(19) United States
(12) Patent Application Publication
(10) Pub. No.: US 2003/0169816 A1
(43) Pub. Date: Sep. 11, 2003

(54) Adaptive universal variable length codeword coding for digital video content

(76) Inventors: Limin Wang, San Diego, CA (US); Krit Panusopone, San Diego, CA (US); Rajeev Gandhi, San Diego, CA (US); Yue Yu, San Diego, CA (US); Ajay Luthra, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/349,003

(22) Filed: Jan. 21, 2003

Related U.S. Application Data
(60) Provisional application No. 60/350,862, filed on Jan. 22, 2002.

(51) Int. Cl. H04N 7/12

(52) U.S. Cl. 375/240.12; 375/240; 375/240.01

(57) ABSTRACT

A method and system of encoding and decoding possible outcomes of events of digital video content. The digital video content comprises a stream of pictures, slices, or macroblocks which can each be intra, predicted or bi-predicted pictures, slices, or macroblocks. The method comprises generating and decoding a stream of bits that represent the outcomes using entries in a lookup table that are periodically rearranged based on historical probabilities of the possible outcomes. The historical probabilities of the possible outcomes are computed by counting occurrences of each of the encoded and decoded outcomes in the stream of pictures, slices, or macroblocks. The periodic rearrangement of the entries in the lookup tables used by the encoder and the decoder is synchronized so that the stream of bits representing the encoded outcomes can be correctly decoded.

### RELATED APPLICATIONS

The present application claims priority under 35 U.S.C. §119(e) from the following previously-filed Provisional Patent Application, U.S. Application No. 60/350,862, filed Jan. 22, 2002 by Limin Wang et al., entitled “Adaptive UVLC Coding for H.26L,” and which is incorporated herein by reference in its entirety.

### BACKGROUND

Video compression is used in many current and emerging products. It is at the heart of digital television set-top boxes (STBs), digital satellite systems (DSSs), high definition television (HDTV) decoders, digital versatile disk (DVD) players, video conferencing, Internet video and multimedia content, and other digital video applications. Without video compression, the number of bits required to represent digital video content can be extremely large, making it difficult or even impossible for the digital video content to be efficiently stored, transmitted, or viewed.

The digital video content comprises a stream of pictures that can be displayed as an image on a television receiver, computer monitor, or some other electronic device capable of displaying digital video content. A picture that is displayed in time before a particular picture is in the “backward direction” in relation to the particular picture. Likewise, a picture that is displayed in time after a particular picture is in the “forward direction” in relation to the particular picture.

Each picture can be divided into slices consisting of macroblocks (MBs). A slice is a group of macroblocks and a macroblock is a rectangular group of pixels. A typical macroblock size is 16 by 16 pixels.

The general idea behind video coding is to remove data from the digital video content that is “non-essential.” The decreased amount of data then requires less bandwidth for broadcast or transmission. After the compressed video data has been transmitted, it must be decoded, or decompressed. In this process, the transmitted video data is processed to generate approximation data that is substituted into the video data to replace the “non-essential” data that was removed in the coding process.

Video coding transforms the digital video content into a compressed form that can be stored using less space and transmitted using less bandwidth than uncompressed digital video content. It does so by taking advantage of temporal and spatial redundancies in the pictures of the video content. The digital video content can be stored in a storage medium such as a hard drive, DVD, or some other non-volatile storage unit.

There are numerous video coding methods that compress the digital video content. Consequently, video coding standards have been developed to standardize the various video coding methods so that the compressed digital video content is rendered in formats that a majority of video encoders and decoders can recognize. For example, the Motion Picture Experts Group (MPEG) and International Telecommunication Union (ITU-T) have developed video coding standards that are in wide use. Examples of these standards include the MPEG-1, MPEG-2, MPEG-4, ITU-T H.261, and ITU-T H.263 standards.

However, as the demand for higher resolutions, more complex graphical content, and faster transmission time increases, so does the need for better video compression methods. To this end, a new video coding standard is currently being developed. This new video coding standard is called the MPEG-4 Part 10 Advanced Video Coding (AVC)/H.264 standard.

Most modem video coding standards, including the MPEG-4 Part 10 AVC/H.264 standard, are based in part on universal variable length codeword (UVLC) coding. In UVLC coding, a UVLC table is used to encode the syntax, or events, associated with a particular picture, slice, or macroblock. The number of bits that are required to encode a particular outcome of an event depends on its position in the UVLC table. The positions of particular outcomes in the UVLC table are based on a probability distribution. This encoding procedure generates a stream of bits that can then be decoded by a decoder by using a similar UVLC table.

However, a problem with traditional UVLC coding is that its events' possible outcomes have fixed probability distributions. In other words, the same number of bits are used to encode a particular outcome of an event regardless of its frequency of use. However, in many applications, the probability of a possible outcome can vary significantly from picture to picture, slice to slice, or macroblock to macroblock. Thus, there is a need in the art for a method of bit stream generation using adaptive UVLC so that less bits are used in the coding process.

### SUMMARY

In one of many possible embodiments, the present invention provides a method of encoding possible outcomes of events of digital video content resulting in encoded outcomes. The digital video content comprises a stream of pictures, slices, or macroblocks which can each be intra, predicted or bi-predicted pictures, slices, or macroblocks. The method comprises generating a stream of bits that represent the encoded outcomes using entries in a lookup table that are periodically rearranged based on historical probabilities of the possible outcomes. The historical probabilities of the possible outcomes are computed by counting occurrences of each of the encoded outcomes in the stream of pictures, slices, or macroblocks. The periodic rearrangement of the entries in the lookup table is synchronized with a periodic rearrangement of entries in a lookup table used by a decoder so that the stream of bits representing the encoded outcomes can be correctly decoded.

Another embodiment of the present invention provides a method of decoding possible outcomes of events of the digital video content resulting in decoded outcomes. The method comprises decoding a stream of bits that has been generated by an encoder and that represents encoded outcomes. The method uses entries in a lookup table that are periodically rearranged based on historical probabilities of the possible outcomes. The historical probabilities of the possible outcomes are computed by counting occurrences of each of the decoded outcomes in the stream of pictures, slices, or macroblocks. The periodic rearrangement of the entries in the lookup table is synchronized with a periodic rearrangement of entries in a lookup table used by an encoder so that the stream of bits representing the encoded outcomes can be correctly decoded.

Another embodiment of the present invention provides an encoder for encoding possible outcomes of events of digital video content resulting in encoded outcomes. The digital video content comprises a stream of pictures, slices, or macroblocks which can each be intra, predicted or bi-predicted pictures, slices, or macroblocks. The encoder comprises a lookup table with entries that correspond to the possible outcomes. Each of the entries are associated with a unique codeword. The encoder also comprises a counter that counts occurrences of each of the encoded outcomes in the stream of pictures, slices, or macroblocks and computes historical probabilities of the possible outcomes. The entries in the lookup table are periodically rearranged based on the historical probabilities of the possible outcomes and are used by the encoder to generate a stream of bits that represents the encoded outcomes. The periodic rearrangement of the entries in the lookup table is synchronized with a periodic rearrangement of entries in a lookup table used by a decoder so that the encoded outcomes can be successfully decoded.

Another embodiment of the present invention provides a decoder for decoding possible outcomes of events of digital video content resulting in decoded outcomes. The digital video content comprises a stream of pictures, slices, or macroblocks which can each be intra, predicted or bi-predicted pictures, slices, or macroblocks. The decoder comprises a lookup table with entries that correspond to the possible outcomes. Each of the entries are associated with a unique codeword. The decoder also comprises a counter that counts occurrences of each of the decoded outcomes in the stream of pictures, slices, or macroblocks and computes historical probabilities of the possible outcomes. The entries in the lookup table are periodically rearranged based on the historical probabilities of the possible outcomes and are used by the decoder to decode a stream of bits that represents the encoded outcomes. The periodic rearrangement of the entries in the lookup table is synchronized with a periodic rearrangement of entries in a lookup table used by an encoder so that the encoded outcomes can be successfully decoded.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates an exemplary sequence of three types of pictures according to an embodiment of the present invention, as defined by an exemplary video coding standard such as the MPEG-4 Part 10 AVC/H.264 standard.

FIG. 2 shows that each picture is preferably divided into one or more slices consisting of macroblocks.

FIG. 3 shows a preferable implementation of an adaptive UVLC coding method according to an embodiment of the present invention.

FIG. 4 illustrates an implementation of a sliding window embodiment of the present invention.

Throughout the drawings, identical reference numbers designate similar, but not necessarily identical, elements.

### DETAILED DESCRIPTION

The present specification provides a method of bit stream generation using adaptive universal variable length codeword (UVLC) coding. The method can be used in any digital video coding scheme that generates an encoded bit stream by means of a look up table. In particular, the method can be implemented in the UVLC and context-based adaptive binary arithmetic coding (CABAC) coding schemes found in the MPEG-4 Part 10 AVC/H.264 video coding standard.

As noted above, the MPEG-4 Part 10 AVC/H.264 standard is a new standard for encoding and compressing digital video content. The documents establishing the MPEG-4 Part 10 AVC/H.264 standard are hereby incorporated by reference, including the “Joint Final Committee Draft (JFCD) of Joint Video Specification” issued on Aug. 10, 2002 by the Joint Video Team (JVT). (ITU-T Rec. H.264 & ISO/IEC 14496-10 AVC). The JVT consists of experts from MPEG and ITU-T. Due to the public nature of the MPEG-4 Part 10 AVC/H.264 standard, the present specification will not attempt to document all the existing aspects of MPEG-4 Part 10 AVC/H.264 video coding, relying instead on the incorporated specifications of the standard.

The current method can be used in any general digital video coding algorithm or system requiring bit stream generation. It can be modified and used to encode and decode the events associated with a picture, slice, or macroblock as best serves a particular standard or application. Thus, even though the embodiments described herein deal principally with UVLC coding, other embodiments apply to other video coding schemes, such as CABAC and others, for example.

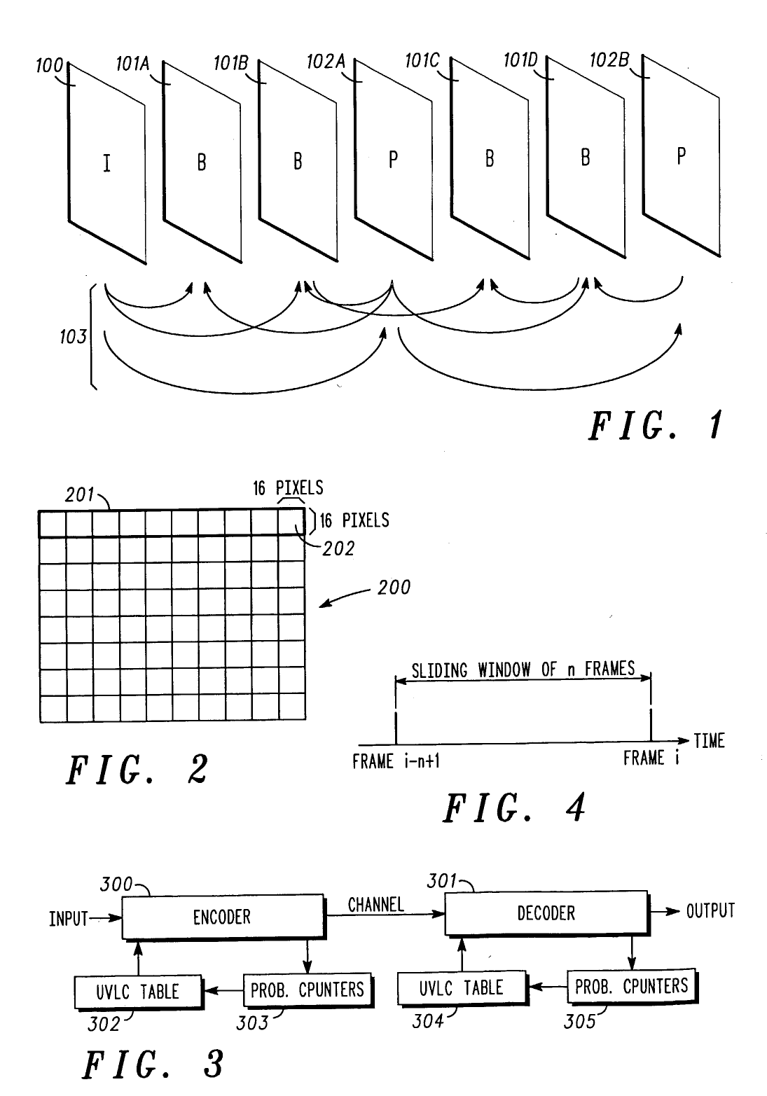

As shown in FIG. 1, there are preferably three types of pictures that can be used in the video coding method. Three types of pictures are defined to support random access to stored digital video content while exploring the maximum redundancy reduction using temporal prediction with motion compensation. The three types of pictures are intra (I) pictures (100), predicted (P) pictures (102a,b), and bi-predicted (B) pictures (101a-d). An I picture (100) provides an access point for random access to stored digital video content. Intra pictures (100) are encoded without referring to reference pictures and can be encoded with moderate compression.

A predicted picture (102a,b) is encoded using an I, P, or B picture that has already been encoded as a reference picture. The reference picture can be in either the forward or backward temporal direction in relation to the P picture that is being encoded. The predicted pictures (102a,b) can be encoded with more compression than the intra pictures (100).

A bi-predicted picture (101a-d) is encoded using two temporal reference pictures. An aspect of the present invention is that the two temporal reference pictures can be in the same or different temporal direction in relation to the B picture that is being encoded. Bi-predicted pictures (101a-d) can be encoded with the most compression out of the three picture types.

Reference relationships (103) between the three picture types are illustrated in FIG. 1. For example, the P picture (102a) can be encoded using the encoded I picture (100) as its reference picture. The B pictures (101a-d) can be encoded using the encoded I picture (100) and the encoded P pictures (102a,b) as its reference pictures, as shown in FIG. 1. Encoded B pictures (101a-d) can also be used as reference pictures for other B pictures that are to be encoded. For example, the B picture (101c) of FIG. 1 is shown with two other B pictures (101b and 110d) as its reference pictures.

The number and particular order of the I (100), B (101a-d), and P (102a,b) pictures shown in FIG. 1 are given as an exemplary configuration of pictures, but are not necessary to implement the present invention. Any number of I, B, and P pictures can be used in any order to best serve a particular application. The MPEG-4 Part 10 AVC/H.264 standard does not impose any limit to the number of B pictures between two reference pictures nor does it limit the number of pictures between two I pictures.

FIG. 2 shows that each picture (200) is preferably divided into slices consisting of macroblocks. A slice (201) is a group of macroblocks and a macroblock (202) is a rectangular group of pixels. As shown in FIG. 2, a preferable macroblock (202) size is 16 by 16 pixels.

A preferable UVLC table that can be used will now be explained in detail. Table 1 illustrates a preferable UVLC codeword structure. As shown in Table 1, there is a code number associated with each codeword.

TABLE 1
UVLC codeword structure

| Code | |
|---|---|
| number | Codeword |
| 0 | 1 |
| 1 | 001 |
| 2 | 011 |
| 3 | 00001 |
| 4 | 00011 |
| 5 | 01001 |
| 6 | 01011 |
| 7 | 0000001 |
| 8 | 0000011 |
| 9 | 0001001 |
| 10 | 0001011 |
| 11 | 0100001 |
| . . . | . . . |

As shown in Table 1, a codeword is a string of bits that can be used to encode a particular outcome of an event. The length in bits of the codewords increase as their corresponding code numbers increase. For example, code number 0 has a codeword that is only 1 bit. Code number 11, however, has a codeword that is 7 bits in length. The codeword assignments to the code numbers in Table 1 are exemplary in nature and can be modified as best serves a particular application.

Table 2 shows the connection between codewords and preferable events that are to be encoded. The events of Table 2 are exemplary in nature and are not the only types of events that can be coded according to an embodiment of the present invention. As shown in Table 2, some of the exemplary events, or syntax, that are to be encoded are RUN, MB_Type Intra, MB_Type Inter, Intra_pred_mode, motion vector data (MVD), coded block pattern (CBP) intra and inter, Tcoeff_chroma_DC, Tcoeff_chroma_AC, and Tcoeff_luma. These events are described in detail in the MPEG-4 Part 10 AVC/H.264 video coding standard and therefore will not be discussed in the present specification.

TABLE 2
Connection between Code Numbers and Events that are to be Encoded

| | | | | | | | | | | | Tcoeff_ | | | |
|---|---|---|---|---|---|---|---|---|---|---|---|---|---|---|
| | | | | Intra_ | | | | | Tcoeff_ | | chroma_AC | | | |
| | | | | pred_ | | | | | chroma_ | | Tcoeff_luma | | Tcoeff_luma | |
| Code | | MB_Type | | mode | | | CBP | | DC | | Simple scan | | Double scan | |
| number | Run | Intra | Inter | Prob0 | Prob1 | MVD | Intra | Inter | Level | Run | Level | Run | Level | Run |
| 0 | 0 | Intra4 × 4 | 16 × 16 | 0 | 0 | 0 | 47 | 0 | EOB | — | EOB | — | EOB | — |
| 1 | 1 | 0, 0, 0 | 16 × 8 | 1 | 0 | 1 | 31 | 16 | 1 | 0 | 1 | 0 | 1 | 0 |
| 2 | 2 | 1, 0, 0 | 8 × 16 | 0 | 1 | | 15 | 1 | −1 | 0 | −1 | 0 | −1 | 0 |
| 3 | 3 | 2, 0, 0 | 8 × 8 | 0 | 2 | 2 | 0 | 2 | 2 | 0 | 1 | 1 | 1 | 1 |
| 4 | 4 | 3, 0, 0 | 8 × 4 | 1 | 1 | −2 | 23 | 4 | −2 | 0 | −1 | 1 | −1 | 1 |
| 5 | 5 | 0, 1, 0 | 4 × 8 | 2 | 0 | 3 | 27 | 8 | 1 | 1 | 1 | 2 | 2 | 0 |
| 6 | 6 | 1, 1, 0 | 4 × 4 | 3 | 0 | −3 | 29 | 32 | −1 | 1 | −1 | 2 | −2 | 0 |
| 7 | 7 | 2, 1, 0 | Intra4 × 4 | 2 | 1 | 4 | 30 | 3 | 3 | 0 | 2 | 0 | 1 | 2 |
| 8 | 8 | 3, 1, 0 | 0, 0, 0 | 1 | 2 | −4 | 7 | 5 | −3 | 0 | −2 | 0 | −1 | 2 |
| 9 | 9 | 0, 2, 0 | 1, 0, 0 | 0 | 3 | 5 | 11 | 10 | 2 | 1 | 1 | 3 | 3 | 0 |
| 10 | 10 | 1, 2, 0 | 2, 0, 0 | 0 | 4 | −5 | 13 | 12 | −2 | 1 | −1 | 3 | −3 | 0 |
| 11 | 11 | 2, 2, 0 | 3, 0, 0 | 1 | 3 | 6 | 14 | 15 | 1 | 2 | 1 | 4 | 4 | 0 |
| 12 | 12 | 3, 2, 0 | 0, 1, 0 | 2 | 2 | −6 | 39 | 47 | −1 | 2 | −1 | 4 | −4 | 0 |
| 13 | 13 | 0, 0, 1 | 1, 1, 0 | 3 | 1 | 7 | 43 | 7 | 1 | 3 | 1 | 5 | 5 | 0 |
| 14 | 14 | 1, 0, 1 | 2, 1, 0 | 4 | 0 | −7 | 45 | 11 | −1 | 3 | −1 | 5 | −5 | 0 |
| 15 | 15 | 2, 0, 1 | 3, 1, 0 | 5 | 0 | 8 | 46 | 13 | 4 | 0 | 3 | 0 | 1 | 3 |
| 16 | 16 | 3, 0, 1 | 0, 2, 0 | 4 | 1 | −8 | 16 | 14 | −4 | 0 | −3 | 0 | −1 | 3 |
| 17 | 17 | 0, 1, 1 | 1, 2, 0 | 3 | 2 | 9 | 3 | 6 | 3 | 1 | 2 | 1 | 1 | 4 |
| 18 | 18 | 1, 1, 1 | 2, 2, 0 | 2 | 3 | −9 | 5 | 9 | −3 | 1 | −2 | 1 | −1 | 4 |
| 19 | 19 | 2, 1, 1 | 3, 2, 0 | 1 | 4 | 10 | 10 | 31 | 2 | 2 | 2 | 2 | 2 | 1 |
| 20 | 20 | 3, 1, 1 | 0, 0, 1 | 0 | 5 | −10 | 12 | 35 | −2 | 2 | −2 | 2 | −2 | 1 |
| 21 | 21 | 0, 2, 1 | 1, 0, 1 | 1 | 5 | 11 | 19 | 37 | 2 | 3 | 1 | 6 | 3 | 1 |
| 22 | 22 | 1, 2, 1 | 2, 0, 1 | 2 | 4 | −11 | 21 | 42 | −2 | 3 | −1 | 6 | −3 | 1 |
| 23 | 23 | 2, 2, 1 | 3, 0, 1 | 3 | 3 | 12 | 26 | 44 | 5 | 0 | 1 | 7 | 6 | 0 |
| 24 | 24 | 3, 2, 1 | 0, 1, 1 | 4 | 2 | −12 | 28 | 33 | −5 | 0 | −1 | 7 | −6 | 0 |
| 25 | 25 | | 1, 1, 1 | 5 | 1 | 13 | 35 | 34 | 4 | 1 | 1 | 8 | 7 | 0 |
| 26 | 26 | | 2, 1, 1 | 5 | 2 | −13 | 37 | 36 | −4 | 1 | −1 | 8 | −7 | 0 |
| 27 | 27 | | 3, 1, 1 | 4 | 3 | 14 | 42 | 40 | 3 | 2 | 1 | 9 | 8 | 0 |
| 28 | 28 | | 0, 2, 1 | 3 | 4 | −14 | 44 | 39 | −3 | 2 | −1 | 9 | −8 | 0 |
| 29 | 29 | | 1, 2, 1 | 2 | 5 | 15 | 1 | 43 | 3 | 3 | 4 | 0 | 9 | 0 |
| 30 | 30 | | 2, 2, 1 | 3 | 5 | −15 | 2 | 45 | −3 | 3 | −4 | 0 | −9 | 0 |
| 31 | 31 | | 3, 2, 1 | 4 | 4 | 16 | 4 | 46 | 6 | 0 | 5 | 0 | 10 | 0 |
| 32 | 32 | | | 5 | 3 | −16 | 8 | 17 | −6 | 0 | −5 | 0 | −10 | 0 |
| 33 | 33 | | | 5 | 4 | 17 | 17 | 18 | 5 | 1 | 3 | 1 | 4 | 1 |
| 34 | 34 | | | 4 | 5 | −17 | 18 | 20 | −5 | 1 | −3 | 1 | −4 | 1 |
| 35 | 35 | | | 5 | 5 | 18 | 20 | 24 | 4 | 2 | 3 | 2 | 2 | 2 |
| 36 | 36 | | | | | −18 | 24 | 19 | −4 | 2 | −3 | 2 | −2 | 2 |
| 37 | 37 | | | | | 19 | 6 | 21 | 4 | 3 | 2 | 3 | 2 | 3 |
| 38 | 38 | | | | | −19 | 9 | 26 | −4 | 3 | −2 | 3 | −2 | 3 |
| 39 | 39 | | | | | 20 | 22 | 28 | 7 | 0 | 2 | 4 | 2 | 4 |
| 40 | 40 | | | | | −20 | 25 | 23 | −7 | 0 | −2 | 4 | −2 | 4 |
| 41 | 41 | | | | | 21 | 32 | 27 | 6 | 1 | 2 | 5 | 2 | 5 |
| 42 | 42 | | | | | −21 | 33 | 29 | −6 | 1 | −2 | 5 | −2 | 5 |
| 43 | 43 | | | | | 22 | 34 | 30 | 5 | 2 | 2 | 6 | 2 | 6 |
| 44 | 44 | | | | | −22 | 36 | 22 | −5 | 2 | −2 | 6 | −2 | 6 |
| 45 | 45 | | | | | 23 | 40 | 25 | 5 | 3 | 2 | 7 | 2 | 7 |
| 46 | 46 | | | | | −23 | 38 | 38 | −5 | 3 | −2 | 7 | −2 | 7 |
| 47 | 47 | | | | | 24 | 41 | 41 | 8 | 0 | 2 | 8 | 11 | 0 |
| | . . . | | | | | . . . | | | . . . | . . . | . . . | . . . | . . . | . . . |

As shown in Table 2, each event has several possible outcomes. For example, the outcomes of MB_Type (inter) are 16×16, 16×8, 8×16, 8×8, etc. Each outcome is assigned a code number associated with a codeword. The encoder can then encode particular outcome by placing its codeword into the bit stream that is sent to the decoder. The decoder then decodes the correct outcome by using an identical UVLC table. For example, the 16×16 outcome (inter_{—}16×16) is assigned a code number of 0 and a codeword of ‘1.’ To encode inter_{—}16×16, the encoder places a ‘1’ in the bit stream. Similarly, the 4×4 outcome (inter_{—}4×4) is assigned a code number of 6 and a codeword of ‘01011.’ To encode inter_{—}4×4, the encoder places a ‘01011’ in the bit stream.

As shown in Table 1, the lengths in bits of VLC codewords are 1, 3, 3, 5, 5, 5, 5, 7, 7, 7, . . . . This assumes that an event to be encoded has a probability distribution of ½, ⅛, ⅛, 1/32, 1/32, 1/32, 1/32, 1/128, 1/128, . . . for its outcomes. For example, Table 3 lists the first 15 possible outcomes for the exemplary MB_Type (inter) event given in Table 2 along with its associated code numbers, codeword lengths, and assumed probabilities.

TABLE 3
First 15 Possible Outcomes for MB_Type (inter) Event

| Code | Codeword | MB_Type (inter) | Assumed |
|---|---|---|---|
| number | Length | Outcome | Probability |
| 0 | 1 | 16 × 16 | 1/2 |
| 1 | 3 | 16 × 8 | 1/8 |
| 2 | 3 | 8 × 16 | 1/8 |
| 3 | 5 | 8 × 8 | 1/32 |
| 4 | 5 | 8 × 4 | 1/32 |
| 5 | 5 | 4 × 8 | 1/32 |
| 6 | 5 | 4 × 4 | 1/32 |
| 7 | 7 | Intra4 × 4 | 1/128 |
| 8 | 7 | 0, 0, 0 | 1/128 |
| 9 | 7 | 1, 0, 0 | 1/128 |
| 10 | 7 | 2, 0, 0 | 1/128 |
| 11 | 7 | 3, 0, 0 | 1/128 |
| 12 | 7 | 0, 1, 0 | 1/128 |
| 13 | 7 | 1, 1, 0 | 1/128 |
| 14 | 7 | 2, 1, 0 | 1/128 |

As shown in the example of Table 3, it is assumed that each possible has a fixed probability. This assumption may not be valid. For example, the probability of inter 4×4 can vary significantly from picture to picture, from slice to slice, or from macroblock to macroblock. In the example of Table 3, inter_{—}4×4 has a code number of 6 and a code word of length 5. However, inter_{—}4×4 could become the most popular coding mode for a particular sequence of pictures, slices, or macroblocks. However, with a fixed UVLC table, it has to be encoded with 5 bits, instead of with 1 bit. If, in this situation, inter_{—}4×4 could be coded with 1 bit instead of with 5 bits, the coding process would be more efficient and potentially require far fewer bits. On the other hand, inter_{—}16×16 might be the least popular mode for a particular sequence. However, based on a fixed UVLC table, it has to always be encoded with 1 bit. This hypothetical illustrates how if the actual probability distribution of an event is far from the assumed probability distribution, the performance of a fixed UVLC table is not optimal.

A preferable method of adaptive UVLC coding will now be explained in connection with Table 4 and Table 5. According to an embodiment of the present invention, an individual outcome of an event (e.g. inter_{—}4×4) is moved up or down in the UVLC table according to its probability. For example, if the history shows that inter_{—}4×4 is the most popular code mode, the outcome inter_{—}4×4 is moved to the top of the UVLC table. At the same time, the other possible outcomes are pushed down in the UVLC table, as shown in Table 4.

TABLE 4
First 15 Possible Outcomes for MB_Type (inter) Event where
inter_4 × 4 has been Moved to the Top of the UVLC Table

| Code | Codeword | MB_Type (inter) | Assumed |
|---|---|---|---|
| number | Length | Outcome | Probability |
| 0 | 1 | 4 × 4 | 1/2 |
| 1 | 3 | 16 × 16 | 1/8 |
| 2 | 3 | 16 × 8 | 1/8 |
| 3 | 5 | 8 × 16 | 1/32 |
| 4 | 5 | 8 × 8 | 1/32 |
| 5 | 5 | 8 × 4 | 1/32 |
| 6 | 5 | 4 × 8 | 1/32 |
| 7 | 7 | Intra4 × 4 | 1/128 |
| 8 | 7 | 0, 0, 0 | 1/128 |
| 9 | 7 | 1, 0, 0 | 1/128 |
| 10 | 7 | 2, 0, 0 | 1/128 |
| 11 | 7 | 3, 0, 0 | 1/128 |
| 12 | 7 | 0, 1, 0 | 1/128 |
| 13 | 7 | 1, 1, 0 | 1/128 |
| 14 | 7 | 2, 1, 0 | 1/128 |

As shown in Table 4, inter_{—}4×4 now has a code number of 0 and a codeword length of 1 bit. By altering the UVLC table in this way, far fewer bits have to be included in the encoded bit stream than if a fixed UVLC table were instead used.

Likewise, if the probability history later shows that inter_{—}16×16 is the least popular inter code mode of the 15 possible outcomes in the example of Table 4, it is moved to the bottom of the UVLC table, as shown in Table 5.

TABLE 5
First 15 Possible Outcomes for MB_Type (inter) Event where
inter_16 × 16 has been Moved to the Bottom of the UVLC Table

| Code | Codeword | MB_Type (inter) | Assumed |
|---|---|---|---|
| number | Length | Outcome | Probability |
| 0 | 1 | 4 × 4 | 1/2 |
| 1 | 3 | 16 × 8 | 1/8 |
| 2 | 3 | 8 × 16 | 1/8 |
| 3 | 5 | 8 × 8 | 1/32 |
| 4 | 5 | 8 × 4 | 1/32 |
| 5 | 5 | 4 × 8 | 1/32 |
| 6 | 5 | Intra4 × 4 | 1/32 |
| 7 | 7 | 0, 0, 0 | 1/128 |
| 8 | 7 | 1, 0, 0 | 1/128 |
| 9 | 7 | 2, 0, 0 | 1/128 |
| 10 | 7 | 3, 0, 0 | 1/128 |
| 11 | 7 | 0, 1, 0 | 1/128 |
| 12 | 7 | 1, 1, 0 | 1/128 |
| 13 | 7 | 2, 1, 0 | 1/128 |
| 14 | 7 | 16 × 16 | 1/128 |

As shown in Table 5, inter_{—}16×16 now has a code number of 14 and a codeword length of 7. By altering the UVLC table in this way, outcomes that are more likely to occur than inter_{—}16×16 are encoded with fewer bits than is

The probability history information is preferably available to both the encoder and the decoder. Thus, the UVLC table used by the decoder can be updated correctly and the codewords can be correctly decoded.

It is important to note that the assumption of probability distribution is not changed in this preferable method of adaptive UVLC coding. Rather, the more popular outcomes are encoded with less bits and the less popular outcomes are encoded with more bits by moving the outcomes of an event up or down in the UVLC table. The adaptation is applied to all the events in the UVLC table, such as RUN, MB-Type (intra), MVD, etc.

A preferable implementation of an adaptive UVLC coding method will now be described in connection with FIG. 3. The encoding can start with a default UVLC table (302) such as the one shown in Table 3. The default UVLC table (302) can also be a lookup table for CABAC coding or for other types of digital video coding as well. The term “UVLC table” will be used hereafter and in the appended claims, unless otherwise specifically denoted, to designate any lookup table that is used in adaptive UVLC coding or in other types of digital video coding, such as CABAC coding.

As shown in FIG. 3, both the encoder (300) and decoder (301) have counters (303, 305) that are preferably set to count the occurrences of each of the outcomes of each of the possible events. For example, the counters (303, 305) count how many times the outcome inter_{—}4×4 occurs at both the encoder (300) and decoder (301) ends. After the encoder (300) encodes an outcome of an event, its corresponding counter (303) is preferably updated automatically to reflect the encoding of that particular outcome. Likewise, after the decoder (301) decodes an outcome of an event, its corresponding counter (305) is also preferably updated automatically to reflect the decoding of that particular outcome. According to an embodiment of the present invention, the rule for updating the counters (303, 305) is the same for the encoder (300) and the decoder (301). Hence, the counters (303, 305) are synchronized at both the encoding and decoding ends.

As shown in FIG. 3, the UVLC tables (302, 304) are periodically updated to reflect the results of the counters (303, 305). In other words, the UVLC tables (302, 304) are re-ordered from top to bottom according to the outcomes' historical probabilities as counted by the counters (303, 305). The outcomes with the highest probabilities as counted by the counters (303, 305) will then preferably reside in the highest positions in the UVLC table. Thus, they will be coded using shorter codeword lengths.

According to another embodiment of the present invention, the update frequency of the UVLC tables (302, 304) can vary as best serves a particular application. The update frequency is preferably the same for both the encoder UVLC table (302) and the decoder UVLC table (304) for correct decoding. For example, the update frequency can be on a picture-by-picture basis, frame-by-frame basis, slice-by-slice basis, or macroblock-by-macroblock basis. Another possibility is that the UVLC tables (302, 304) can be updated once there is a significant change in the probability distribution of an event. These update frequency possibilities are not exclusive update frequencies according to an embodiment of the present invention. Rather, any update frequency that best suits a particular application is embodied in the present invention.

An exemplary method of calculating the probability of an outcome of an event will now be explained. Let Pr ob(i, j) be the probability of an outcome j of an event for an agreed-upon updating period i. For example, the agreed-upon updating period can be every frame. The probability of the outcome of the event that is used to update the UVLC tables (302, 304) is calculated as follows:

Pr ob(j)=αPr ob(i−1, j)+(1−α)Pr ob(i, j) (Eq. 1)

where 0≦α<1. Because of the high degree of temporal correlation between the successive frames, the updated UVLC tables (302, 304) based upon the coded frames should be reasonably good for the coming frames. Another embodiment of the present invention is that if a scene change is detected, the UVLC tables (302, 304) are switched back to their default contents and the counters (303, 305) are reset as well. This is because in some applications, updated UVLC tables (302, 304) based on the probability history may not be ideal for a new scene. However, according to another embodiment of the present invention, it is not necessary to switch back to the default UVLC table values when a new scene is encountered.

According to another embodiment of the present invention, separate UVLC tables are used for each of the picture types, I, P, and B. These UVLC tables are preferably updated using the method explained in connection with FIG. 3. There can be separate counters for each of the UVLC tables that count the occurrences of outcomes corresponding to the particular picture types. However, some applications may not require that separate UVLC tables be used for the different picture types. For example, a single UVLC table can be used for one, two, or three different picture types.

According to another embodiment of the present invention, a sliding window is used by the counters in accumulating the probability statistics to account for changes in video characteristics over time. The probability counters preferably throw away outcome occurrence data that is “outdated,” or outside the sliding window range. The sliding window method is preferable in many applications because without it, for example, it takes a much more pronounced effect in the 1001th frame to change the order in the UVLC table than it takes in the 11th frame, for example.

The sliding window implementation in the counters will be explained in connection with FIG. 4. In the following explanation, it is assumed that there are J possible outcomes for an event and that the sliding window covers n frames, as shown in FIG. 4. Let N(i, j) be the counter for outcome j for frame i. The total counter of outcome j within the sliding window is:

$$N ( j ) = {\sum }_{{i}^{′} = i - n + 1}^{i} N ( {i}^{′} , j ) . \qquad ( Eq . 2 )$$

The probability of outcome j is therefore equal to:

$$Prob ( j ) = N ( j ) / {\sum }_{{j}^{′} = 1}^{J} N ( {j}^{′} ) . \qquad ( Eq . 3 )$$

The sliding window adaptation ensures that the statistics are accumulated over a finite period of time. Another characteristic of video sequences is the fact that frames usually have higher correlation to other frames that are temporally close to them than to those that are temporally far from them. This characteristic can be captured by incorporating a weighting factor α (where α<1) in updating the counters for a particular event. Let N(i, j) be the counter for outcome j for frame i. The total counter of outcome j is now given by:

$$N ( j ) {\sum }_{{i}^{′} = i - n + 1}^{i} {α}^{i - {i}^{′}} N ( {i}^{′} , j ) . \qquad ( Eq . 4 )$$

The probability of outcome j is therefore equal to:

$$Prob ( j ) = N ( j ) / {\sum }_{{j}^{′} = 1}^{J} N ( {j}^{′} ) . \qquad ( Eq . 5 )$$

This type of weighting ensures that the current occurrence of an outcome of an event has a higher impact on its probability than the earlier occurrences. However, weighting is optional and is not used in some applications.

The concept of adaptive UVLC can be applied to CABAC. In CABAC, the outcomes of the same events that can be coded in UVLC coding are coded using adaptive binary code. The code numbers are first converted into binary data. The binary data are then fed into adaptive binary arithmetic code. The smaller the code number is, the fewer bits it is binarized into. The assignment of the code numbers to the outcomes of each event is typically fixed. However, the assignment of the code numbers to the outcomes of each event can be adapted according to the probability history of the outcomes.

Adaptive CABAC is implemented using the same method as was explained for adaptive UVLC coding in FIG. 3. However, instead of updating UVLC tables, the counters update the assignments of code numbers to the outcomes of each event for CABAC coding.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A method of encoding possible outcomes of events of digital video content resulting in encoded outcomes, said digital video content comprising a stream of pictures, slices, or macroblocks which can each be intra, predicted or bi-predicted pictures, slices, or macroblocks, said method comprising generating a stream of bits that represent said encoded outcomes using entries in a lookup table that are periodically rearranged in said lookup table based on historical probabilities of said possible outcomes.

2. The method of claim 1, wherein said entries in said lookup table correspond to said possible outcomes and are each associated with a unique codeword.

3. The method of claim 2, wherein said historical probabilities of said possible outcomes are computed by counting occurrences of each of said encoded outcomes in said stream of said pictures, said slices, or said macroblocks.

4. The method of claim 3, wherein said periodic rearrangement comprises re-assigning said entries in said lookup table to different codewords.

5. The method of claim 4, wherein said re-assigning comprises assigning shorter codewords to outcomes with a high historical probability of occurrence and assigning longer codewords to outcomes with a low historical probability of occurrence.

6. The method of claim 5, wherein said lookup table is reset to its default values if a scene change is detected in said stream of pictures, slices, or macroblocks.

7. The method of claim 1, wherein said encoding is adaptive universal variable length codeword encoding and said lookup table is a universal variable length codeword table.

8. The method of claim 1, wherein said encoding is context-based adaptive binary arithmetic encoding and said lookup table is a context-based adaptive binary arithmetic coding table.

9. The method of claim 1, wherein a separate lookup table is used for said intra pictures, slices, or macroblocks.

10. The method of claim 1, wherein a separate lookup table is used for said predicted pictures, slices, or macroblocks.

11. The method of claim 1, wherein a separate lookup table is used for said bi-predicted pictures, slices, or macroblocks.

12. The method of claim 2, wherein said periodic rearrangement of said entries in said lookup table is once every picture.

13. The method of claim 2, wherein said periodic rearrangement of said entries in said lookup table is once every slice.

14. The method of claim 2, wherein said periodic rearrangement of said entries in said lookup table is once every macroblock.

15. The method of claim 3, wherein said computation of said historical probabilities of said possible outcomes ignores said encoded outcomes that occur previous to a time defined by a sliding window, said sliding window covering a definable number of said pictures, said slices, or said macroblocks.

16. The method of claim 3, wherein said computation of said historical probabilities of said possible outcomes incorporates a weighting factor to compensate for temporally close pictures, slices, or macroblocks.

17. The method of claim 1, wherein said periodic rearrangement of said entries in said lookup table is synchronized with a periodic rearrangement of entries in a lookup table used by a decoder so that said encoded outcomes can be successfully decoded.

18. A method of decoding possible outcomes of events of digital video content resulting in decoded outcomes, said digital video content comprising a stream of pictures, slices, or macroblocks which can each be intra, predicted or bi-predicted pictures, slices, or macroblocks, said method comprising decoding a stream of bits that represent encoded outcomes using entries in a lookup table that are periodically rearranged in said lookup table based on historical probabilities of said possible outcomes.

19. The method of claim 18, wherein said entries in said lookup table correspond to said possible outcomes and are each associated with a unique codeword.

20. The method of claim 19, wherein said historical probabilities of said possible outcomes are computed by counting occurrences of each of said decoded outcomes in said stream of said pictures, said slices, or said macroblocks.

21. The method of claim 20, wherein said periodic rearrangement comprises re-assigning said entries in said lookup table to different codewords.

22. The method of claim 21, wherein said re-assigning comprises assigning shorter codewords to outcomes with a high historical probability of occurrence and assigning longer codewords to outcomes with a low historical probability of occurrence.

23. The method of claim 22, wherein said lookup table is reset to its default values if a scene change is detected in said stream of pictures, slices, or macroblocks.

24. The method of claim 18, wherein said decoding is adaptive universal variable length codeword decoding and said lookup table is a universal variable length codeword table.

25. The method of claim 18, wherein said decoding is context-based adaptive binary arithmetic decoding and said lookup table is a context-based adaptive binary arithmetic coding table.

26. The method of claim 18, wherein a separate lookup table is used for said intra pictures, slices, or macroblocks.

27. The method of claim 18, wherein a separate lookup table is used for said predicted pictures, slices, or macroblocks.

28. The method of claim 18, wherein a separate lookup table is used for said bi-predicted pictures, slices, or macroblocks.

29. The method of claim 19, wherein said periodic rearrangement of said entries in said lookup table is once every picture.

30. The method of claim 19, wherein said periodic rearrangement of said entries in said lookup table is once every slice.

31. The method of claim 19, wherein said periodic rearrangement of said entries in said lookup table is once every macroblock.

32. The method of claim 20, wherein said computation of said historical probabilities of said possible outcomes ignores said decoded outcomes that occur previous to a time defined by a sliding window, said sliding window covering a definable number of said pictures, said slices, or said macroblocks.

33. The method of claim 20, wherein said computation of said historical probabilities of said possible outcomes incorporates a weighting factor to compensate for temporally close pictures, slices, or macroblocks.

34. The method of claim 18, wherein said periodic rearrangement of said entries in said lookup table is synchronized with a periodic rearrangement of entries in a lookup table used by an encoder.

35. An encoder for encoding possible outcomes of events of digital video content resulting in encoded outcomes, said digital video content comprising a stream of pictures, slices, or macroblocks which can each be intra, predicted or bi-predicted pictures, slices, or macroblocks, said encoder comprising:
a lookup table comprising entries that correspond to said possible outcomes and that are each associated with a unique codeword; and
a counter that counts occurrences of each of said encoded outcomes in said stream of said pictures, said slices, or said macroblocks and computes historical probabilities of said possible outcomes;
wherein said entries are periodically rearranged in said lookup table based on said historical probabilities of said possible outcomes and are used by said encoder to generate a stream of bits that represents said encoded outcomes.

36. The encoder of claim 35, wherein said periodic rearrangement comprises re-assigning said entries in said lookup table to different codewords.

37. The encoder of claim 36, wherein said re-assigning comprises assigning shorter codewords to outcomes with a high historical probability of occurrence and assigning longer codewords to outcomes with a low historical probability of occurrence.

38. The encoder of claim 35, wherein said lookup table is reset to its default values if said encoder detects a scene change in said stream of pictures, slices, or macroblocks.

39. The encoder of claim 35, wherein said lookup table is a universal variable length codeword table.

40. The encoder of claim 35, wherein said lookup table is a context-based adaptive binary arithmetic coding table.

41. The encoder of claim 35, wherein a separate lookup table is used for said intra pictures, slices, or macroblocks.

42. The encoder of claim 35, wherein a separate lookup table is used for said predicted pictures, slices, or macroblocks.

43. The encoder of claim 35, wherein a separate lookup table is used for said bi-predicted pictures, slices, or macroblocks.

44. The encoder of claim 35, wherein said periodic rearrangement of said entries in said lookup table is once every picture.

45. The encoder of claim 35, wherein said periodic rearrangement of said entries in said lookup table is once every slice.

46. The encoder of claim 35, wherein said periodic rearrangement of said entries in said lookup table is once every macroblock.

47. The encoder of claim 35, wherein said counter comprises a sliding window that allows said counter to ignore said encoded outcomes that occur previous to a time defined by said sliding window, said sliding window covering a definable number of said pictures, said slices, or said macroblocks.

48. The encoder of claim 35, wherein said counter incorporates a weighting factor to compensate for temporally close pictures, slices, or macroblocks.

49. The encoder of claim 35, wherein said periodic rearrangement of said entries in said lookup table is synchronized with a periodic rearrangement of entries in a lookup table used by a decoder so that said encoded outcomes can be successfully decoded.

50. A decoder for decoding possible outcomes of events of digital video content resulting in decoded outcomes, said digital video content comprising a stream of pictures, slices, or macroblocks which can each be intra, predicted or bi-predicted pictures, slices, or macroblocks, said decoder comprising:
a lookup table comprising entries that correspond to said possible outcomes and that are each associated with a unique codeword; and
a counter that counts occurrences of each of said decoded outcomes in said stream of said pictures, said slices, or said macroblocks and computes historical probabilities of said possible outcomes;
wherein said entries are periodically rearranged in said lookup table based on said historical probabilities of said possible outcomes and are used by said decoder to decode a stream of bits that represents encoded outcomes.

51. The decoder of claim 50, wherein said periodic rearrangement comprises re-assigning said entries in said lookup table to different codewords.

52. The decoder of claim 51, wherein said re-assigning comprises assigning shorter codewords to outcomes with a high historical probability of occurrence and assigning longer codewords to outcomes with a low historical probability of occurrence.

53. The decoder of claim 50, wherein said lookup table is reset to its default values if said decoder detects a scene change in said stream of pictures, slices, or macroblocks.

54. The decoder of claim 50, wherein said lookup table is a universal variable length codeword table.

55. The decoder of claim 50, wherein said lookup table is a context-based adaptive binary arithmetic coding table.

56. The decoder of claim 50, wherein a separate lookup table is used for said intra pictures, slices, or macroblocks.

57. The decoder of claim 50, wherein a separate lookup table is used for said predicted pictures, slices, or macroblocks.

58. The decoder of claim 50, wherein a separate lookup table is used for said bi-predicted pictures, slices, or macroblocks.

59. The decoder of claim 50, wherein said periodic rearrangement of said entries in said lookup table is once every picture.

60. The decoder of claim 50, wherein said periodic rearrangement of said entries in said lookup table is once every slice.

61. The decoder of claim 50, wherein said periodic rearrangement of said entries in said lookup table is once every macroblock.

62. The decoder of claim 50, wherein said counter comprises a sliding window that allows said counter to ignore said decoded outcomes that occur previous to a time defined by said sliding window, said sliding window covering a definable number of said pictures, said slices, or said macroblocks.

63. The decoder of claim 50, wherein said counter incorporates a weighting factor to compensate for temporally close pictures, slices, or macroblocks.

64. The decoder of claim 50, wherein said periodic rearrangement of said entries in said lookup table is synchronized with a periodic rearrangement of entries in a lookup table used by an encoder.

65. An encoding system for encoding possible outcomes of events of digital video content resulting in encoded outcomes, said digital video content comprising a stream of pictures, slices, or macroblocks which can each be intra, predicted or bi-predicted pictures, slices, or macroblocks, said system comprising:
means for computing historical probabilities of said possible outcomes by counting occurrences of each of said encoded outcomes in said stream of said pictures; and
means for generating a stream of bits that represents said encoded outcomes using entries in a lookup table that correspond to said possible outcomes, that have unique codewords, and that are periodically rearranged based on said historical probabilities of said possible outcomes.

66. The system of claim 65, further comprising means for re-assigning said entries in said lookup table to different codewords.

67. The system of claim 66, wherein said means for re-assigning said entries in said lookup table to different codewords comprises assigning shorter codewords to outcomes with a high historical probability of occurrence and assigning longer codewords to outcomes with a low historical probability of occurrence.

68. The system of claim 65, further comprising means for resetting said lookup table to its default values if a scene change is detected in said stream of pictures, slices, or macroblocks.

69. The system of claim 65, further comprising means for using a separate lookup table for said intra pictures, slices, or macroblocks.

70. The system of claim 65, further comprising means for using a separate lookup table for said predicted pictures, slices, or macroblocks.

71. The system of claim 65, further comprising means for using a separate lookup table for said bi-predicted pictures, slices, or macroblocks.

72. The system of claim 65, further comprising means for rearranging said entries in said lookup table once every picture.

73. The system of claim 65, further comprising means for rearranging said entries in said lookup table once every slice.

74. The system of claim 65, further comprising means for rearranging said entries in said lookup table once every macroblock.

75. The system of claim 65, further comprising means for ignoring said encoded outcomes that occur previous to a time defined by a sliding window in said computing of said historical probabilities of said possible outcomes, said sliding window covering a definable number of said pictures, said slices, or said macroblocks.

76. The system of claim 65, further comprising means for incorporating a weighting factor to compensate for temporally close pictures, slices, or macroblocks in said computing of said historical probabilities of said possible outcomes.

77. The system of claim 65, further comprising means for synchronizing said periodic rearrangement of said entries in said lookup table with a periodic rearrangement of entries in a lookup table used by a decoder so that said encoded outcomes can be successfully decoded.

78. An decoding system for decoding possible outcomes of events of digital video content resulting in decoded outcomes, said digital video content comprising a stream of pictures, slices, or macroblocks which can each be intra, predicted or bi-predicted pictures, slices, or macroblocks, said system comprising:
means for computing historical probabilities of said possible outcomes by counting occurrences of each of said decoded outcomes in said stream of said pictures; and
means for decoding a stream of bits that represents encoded outcomes using entries in a lookup table that correspond to said possible outcomes, that have unique codewords, and that are periodically rearranged based on said historical probabilities of said possible outcomes.

79. The system of claim 78, further comprising means for re-assigning said entries in said lookup table to different codewords.

80. The system of claim 79, wherein said means for re-assigning said entries in said lookup table to different codewords comprises assigning shorter codewords to outcomes with a high historical probability of occurrence and assigning longer codewords to outcomes with a low historical probability of occurrence.

81. The system of claim 78, further comprising means for resetting said lookup table to its default values if a scene change is detected in said stream of pictures, slices, or macroblocks.

82. The system of claim 78, further comprising means for using a separate lookup table for said intra pictures, slices, or macroblocks.

83. The system of claim 78, further comprising means for using a separate lookup table for said predicted pictures, slices, or macroblocks.

84. The system of claim 78, further comprising means for using a separate lookup table for said bi-predicted pictures, slices, or macroblocks.

85. The system of claim 78, further comprising means for rearranging said entries in said lookup table once every picture.

86. The system of claim 78, further comprising means for rearranging said entries in said lookup table once every slice.

87. The system of claim 78, further comprising means for rearranging said entries in said lookup table once every macroblock.

88. The system of claim 78, further comprising means for ignoring said decoded outcomes that occur previous to a time defined by a sliding window in said computing of said historical probabilities of said possible outcomes, said sliding window covering a definable number of said pictures, said slices, or said macroblocks.

89. The system of claim 78, further comprising means for incorporating a weighting factor to compensate for temporally close pictures, slices, or macroblocks in said computing of said historical probabilities of said possible outcomes.

90. The system of claim 78, further comprising means for synchronizing said periodic rearrangement of said entries in said lookup table with a periodic rearrangement of entries in a lookup table used by an encoder.
